(19) United States
(12) Patent Application Publication
(10) Pub. No.: US 2024/0200731 A1
(43) Pub. Date: Jun. 20, 2024

(54) MODULAR OPEN-AIR SKID WITH ELECTRICAL VARIABLE FREQUENCY DRIVE FOR NATURAL GAS COMPRESSION

(71) Applicants: Monarch Resource Partners LLC, College Station, TX (US); TECO-Westinghouse Motor Company, Round Rock, TX (US)

(72) Inventors: Brett Schubert, College Station, TX (US); Dean Sarandria, Round Rock, TX (US)

(21) Appl. No.: 18/544,273

(22) Filed: Dec. 18, 2023

Related U.S. Application Data
(60) Provisional application No. 63/387,809, filed on Dec. 16, 2022.

(51) Int. Cl. F17D 1/07; F04B 35/04; F04B 39/12

(52) U.S. Cl. CPC F17D 1/07; F04B 35/04; F04B 39/12

(57) ABSTRACT

In various embodiments, a mobile, open-air, electrical skid may provide electrical power from high voltage power lines via one or more electrical components to natural gas compressors at a natural gas compressor site. In several embodiments, the open-air skid may be of a size that can fit on a flat-bed trailer so that the skid can be transported to the site, and the open-air skid may not have side walls to allow for air flowing across the components. The electrical components may include an electric variable frequency drive, a sync reactor, one or more motor relays, an input cabinet, one or more motor control cabinets, a remote cooling unit, and/or other electrical components utilized to start-up one or more natural gas compressors and keep the one or more natural gas compressors running.

### CROSS-REFERENCE TO RELATED APPLICATION

This application claims priority to U.S. Provisional Patent Application No. 63/387,809, filed Dec. 16, 2022, the entirety of which is incorporated herein.

### TECHNICAL FIELD

The described examples generally relate to systems and designs for compression systems, and more specifically, to open-air skids with electrical variable frequency drives for natural gas compression.

### BACKGROUND

In natural gas production networks, natural gas compressors are utilized periodically along the natural gas pipelines to maintain the pressure and flow rate of the natural gas within the pipes. Conventionally, the natural gas compressors are fueled by a portion of the natural gas flowing through the pipes, which results in harmful emissions being exhausted into the environment. Additionally, these natural gas compressors can be located far from general infrastructure, and constructing buildings to house additional equipment at each compression station is costly. Further, any buildings constructed need permits for construction and for hazardous gas collection areas, which increases the costs associated. Therefore, there is a long-felt and unresolved need for a zero-emission, mobile, open-air, electrical skid to power natural gas electric compressors.

### SUMMARY

In one aspect, a system, including: an open-air skid, further including: an electric drive, and a sync reactor; wherein the electric drive and sync reactor provide electrical power to one or more natural gas compressors.

In a second aspect, the system of the first aspect or any other aspect, wherein the open-air skid further includes a step-down transformer that provides utility power from a high voltage power line to the electric drive and sync reactor.

In a third aspect, the system of the second aspect or any other aspect, wherein the open-air skid further includes a plurality of motor control cabinets.

In a fourth aspect, the system of the third aspect or any other aspect, wherein each of the plurality of motor control cabinets is connected to a separate natural gas compressor of the one or more natural gas compressors.

In a fifth aspect, the system of the fourth aspect or any other aspect, wherein the electric drive and the sync reactor provide electrical power to the one or more natural gas compressors includes: providing start-up power to a first natural gas compressor of the one or more natural gas compressors via the electric drive and the sync reactor; transferring the first natural gas compressor from start-up power to utility power provided by the step-down transformer; and providing start-up power to a second natural gas compressor of the one or more natural gas compressors via the electric drive and the sync reactor.

In a sixth aspect, the system of the fifth aspect or any other aspect, wherein the one or more natural gas compressors includes four natural gas compressors.

In a seventh aspect, the system of the sixth aspect or any other aspect, wherein each of the four natural gas compressors exerts up to 2500 horsepower.

In an eighth aspect, the system of the first aspect or any other aspect, wherein the skid further includes: a height in between, and including, 11 feet to 13 feet, a length in between and including 40 feet to 43 feet, and a width in between and including 10 feet to 15 feet.

In a ninth aspect, the system of the first aspect or any other aspect, wherein the skid does not include side walls.

In a tenth aspect, the system of the first aspect or any other aspect, wherein the open-air skid further includes a plurality of motor control cabinets, a step-down transformer, and a remote cooling unit; wherein the remote cooling unit cools the electric drive.

In an eleventh aspect, a method of providing electric power to a first set of one or more natural gas compressors, including: providing an open-air skid at a first site, the open-air skid including: an electric drive, one or more motor control cabinets, a sync reactor, and an input cabinet; connecting the input cabinet to a high voltage power line; providing start-up power to a first natural gas compressor of the first set of one or more natural gas compressors via the electric drive and sync reactor; transferring the first natural gas compressor from start-up power to utility power provided by the step-down transformer; providing start-up power to a second natural gas compressor of the first set of one or more natural gas compressors via the electric drive and the sync reactor; and transferring the second natural gas compressor from start-up power to utility power provided by the step-down transformer.

In a twelfth aspect, the method of the eleventh aspect or any other aspect, wherein transferring the first natural gas compressor from start-up power to utility power provided by the input cabinet includes: syncing, by the sync reactor, a power and frequency of the first natural gas compressor with a power and frequency of the utility power, removing the start-up power provided by the electric drive and sync reactor, and connecting the utility power with the synced first natural gas compressor.

In a thirteenth aspect, the method of the eleventh aspect or any other aspect, further including: providing start-up power to a third natural gas compressor of the first set one or more natural gas compressors via the electric drive and the sync reactor; transferring the third natural gas compressor from start-up power to utility power provided by the input cabinet; providing start-up power to a fourth natural gas compressor of the first set of one or more natural gas compressors via the electric drive and the sync reactor; and transferring the fourth natural gas compressor from start-up power to utility power provided by the input cabinet.

In a fourteenth aspect, the method of the eleventh aspect or any other aspect, wherein the open-air skid further includes: a height in between, and including, 11 feet to 13 feet, a length in between and including 40 feet to 43 feet, and a width in between and including 10 feet to 15 feet.

In a fifteenth aspect, the method of the eleventh aspect or any other aspect, wherein the open-air skid does not include side walls.

In a sixteenth aspect, the method of the eleventh aspect or any other aspect, further including: transporting the open-air skid to a second site; providing start-up power to a third natural gas compressor of a second set of one or more natural gas compressors via the electric drive and sync reactor; transferring the third natural gas compressor from start-up power to utility power provided by the input cabinet; providing start-up power to a fourth natural gas compressor of the second set of one or more natural gas compressors via the electric drive and the sync reactor; and transferring the fourth natural gas compressor from start-up power to utility power provided by the input cabinet.

In addition to the example aspects described above, further aspects and examples will become apparent by reference to the drawings and by study of the following description.

### BRIEF DESCRIPTION OF THE DRAWINGS

FIG. 1A depicts a front view of an example modular skid.

FIG. 1B depicts a top view of an example modular skid.

FIG. 2A depicts a front view of an example modular skid.

FIG. 2B depicts a side view of an example modular skid.

FIG. 2C depicts a detailed view of an example modular skid, taken from FIG. 2B.

FIG. 2D depicts a back view of an example modular skid.

FIG. 2E depicts a cross-sectional view along line 2E-2E from FIG. 2D of an example modular skid.

FIG. 3 depicts a perspective view of an example modular skid.

FIG. 4 depicts a perspective view on an example modular skid.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Briefly described, and according to one embodiment, aspects of the present disclosure generally relate to a mobile, open-air, electrical skid to power natural gas compressors.

In various embodiments, the skid may be a platform on which electrical components may be placed. In several embodiments, the platform may be of a size that can fit on a flat-bed trailer so that the skid can be transported to a site that has one or more natural gas compressors. In some embodiments, the skid may have a roof attached to the platform via one or more supports to cover the electrical components from overhead rain or other hazards, but the platform does not have side walls between the roof and the platform. Generally, regulations require closed-structures to have permits for construction and for hazardous gas collection areas, so the lack of sidewalls, which makes the skid “open-air” allows for the installation of the skid without having to get said permits or create hazardous gas collection areas. The open-air skid also allows for any hazardous gases, should any be created by the electrical components, to be dispersed into the atmosphere.

In many embodiments, the electrical components placed on the skid receive electrical power from step-down transformers connected to high-voltage or medium voltage power lines. The electrical components may include an electric variable drive, a sync reactor, one or more motor relays, a load distribution center, one or more motor control cabinets, uninterruptible power supply, programmable logic controller, power distribution and control system, and/or other electrical components utilized to start-up one or more natural gas compressors and keep the one or more natural gas compressors running.

In several embodiments, each of the electrical components are enclosed to keep dirt, dust, and other hazardous materials, out of the electrical components. In some embodiments, at least one of the electrical components may include at least one filter to further prevent dust, dirt, and other granular hazards out of the at least one electrical component.

In many embodiments, the open-air, electrical skid may supply between 1.5-10 kVa to the one or more natural gas compressors. In one non-limiting example, the open-air, electrical skid can supply power to four natural gas compressors, wherein each of the four natural gas compressors are provided enough power such that each can exert up to 2500 horsepower at the same time. However, the open-air, electrical skid may supply power to more than four natural gas compressors, or less than four natural gas compressors, depending on the needs of the natural gas pipelines and the number of motor relays connected on the skid.

In various embodiments, the sync reactor may combine with an electric variable drive to start the motor of each of the one or more natural gas compressors. The electric variable drive provides the start-up power for the at least one natural gas compressor. The sync reactor manages the current and harmonics to efficiently transfer the compressor motor over to utility power received from the power lines. The sync reactor syncs frequencies of the motor of a first natural gas compressor with the power line frequency (through at least one step-down transformer). Once the first natural gas compressor is started, the sync reactor and drive switch off and the skid provides utility power to the first compressor, which is used to keep the natural gas compressor running after start-up, allowing the sync reactor and drive to start up the second natural gas compressor.

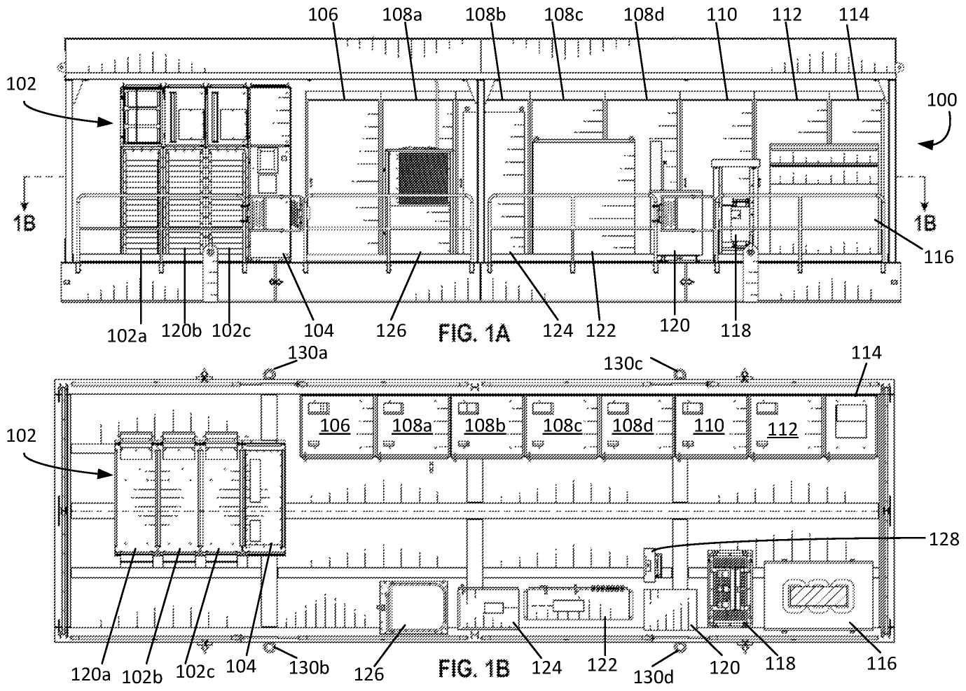

Turning to FIGS. 1A and 1B, a side and a top view of an example electrical, open-air skid are shown, according to one embodiment of the present disclosure. As shown in FIG. 1A, the electrical, open air skid 100 includes a drive 102. The drive 102 may be a medium voltage variable frequency drive, or any other type of drive that can perform the functions as described herein. The drive 102 may include a filter to keep granular hazards out, and may also be connected to a remote cooling unit 126 that runs coolant through the drive 102, each of which allow the variable drive 102 to operate successfully in the outdoor environment. The drive 102 may include slices 102a, 102b, and 102c, that, when combined in certain ways, different voltage and current levels for the drive 102 are achieved, though more or less slices may be included in the drive 102 depending on the needs of the system. The drive 102 may also include mains control cabinet 104 that includes the controls and power supply for the drive 102.

In many embodiments, the skid 100 also includes a drive output cabinet 106 that initially receives the power supply from the drive 102. In multiple embodiments, the skid includes one or more motor control cabinets 108 that each include a motor relay. As shown in FIG. 1A, skid 100 includes four motor control cabinets 108a, 108b, 108c, and 108d, though more or less motor control cabinets may be utilized on the skid 100 depending on the needs of the system. In several embodiments, each of the motor control cabinets 108 controls a motor of a natural gas compressor. As shown in FIG. 1A, since the four motor control cabinets 108a, 108b, 108c, and 108d each control motors of one of four compressors.

In one or more embodiments, the skid 100 also includes feeder cabinets 110 and 112, and input cabinet 114. The input cabinet 114 may receive power from a powerline and send the power to the feeder cabinets 110 and 112. Feeder cabinet 110 may be connected to the drive 102 and relays 108.

In several embodiments, the skid 100 also includes a step-down transformer 116 that steps down the voltage from 4160 volts to 480 volts/208 volts, which controls the electrical loads on the compressors, control panels and auxiliary air compressors on the main compressor. The feeder cabinet 112 may provide power to the step-down transformer 116.

The skid includes a sync cabinet 118 that is connected with the motor control cabinets 108, and which syncs each motor control cabinet 108 to electrical power supplied from the power lines connected to the skid 100 after the drive 102 successfully starts up the compressor controlled by the motor control cabinets 108. FIGS. 1A and 1B also show an additional step-down transformer 120, a power distribution center 122, an uninterruptible power supply and programmable logic controller cabinet 124, and a load distribution center 128 on the skid 100. The skid 100 may have additional electrical components that are utilized to start-up and power the one or more natural gas compressors. Each electrical component or electrical cabinet as shown in the figures may include additional components such as, but not limited to, switches, relays, indicator lights, circuit breakers, contactors, HMIs, and other commonly used electrical components.

The skid 100 may also have connection devices 130, for stabilizing the skid 100 when in transit to a site. Further, the skid 100 may be pre-fabricated before being transported to the site, such that once the skid 100 is placed at the site, the skid 100 can be connected to power lines and/or components connected to power lines at the site.

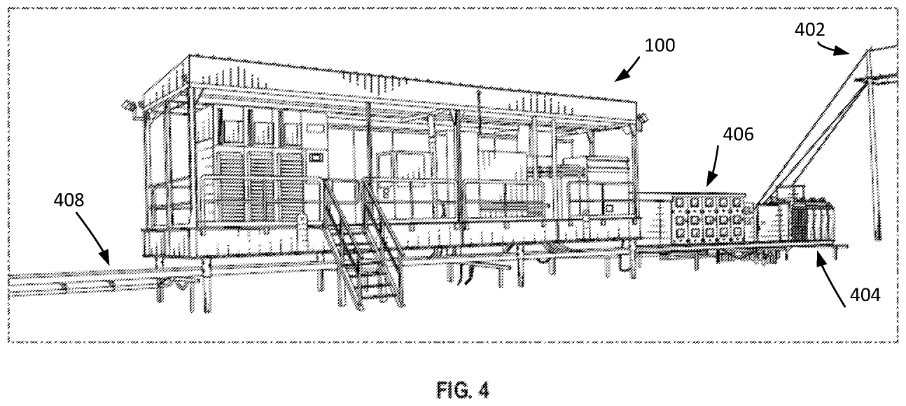

Once the skid 100 is connected to the power line power supply (either directly or indirectly through a series of one or more transformers and/or switchgears as shown in FIG. 4), and the motor control cabinets 108 are each connected to a motor of a compressor, the drive 102 may be switched on to power a first motor control cabinet 108a. The drive 102 provides the initial power to a motor of a first compressor via the first motor control cabinet 108a, and when the motor of the first compressor is started and achieved a certain level of sustained power, the sync reactor 118 syncs the frequency of the motor control cabinet 108a with the power supplied from the power lines via input cabinet 114 to transfer the motor control cabinet 108a from the power supplied by the drive 102 to the utility power. Once the first motor control cabinet 108a is transferred off of the power supplied by the drive 102, the drive 102 may be utilized to start up a second compressor via the second motor control cabinet 108b. This process may continue, with the drive 102 starting up one compressor at a time and the sync reactor 118 syncing the started-up compressors with utility power, until all the natural gas compressors are synced with utility power.

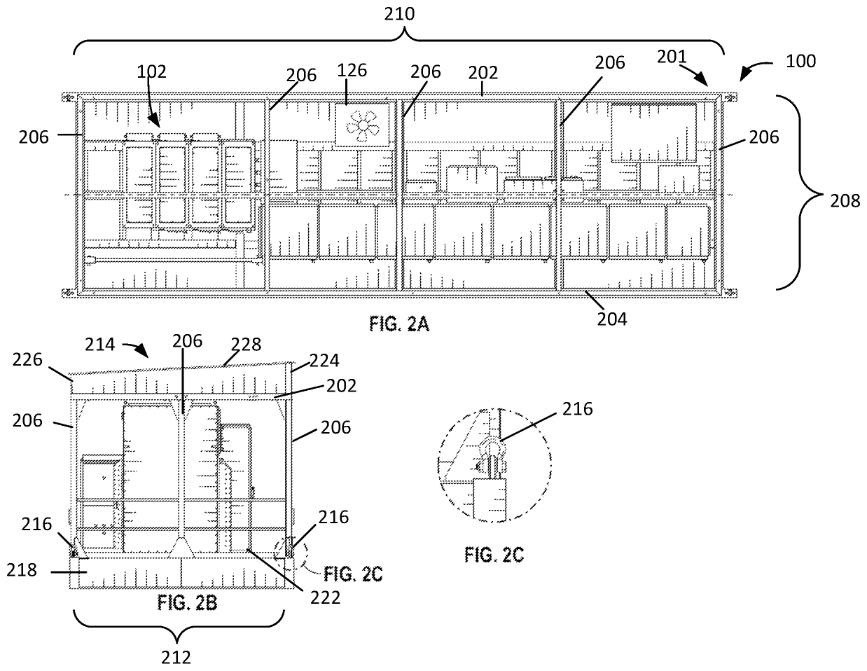

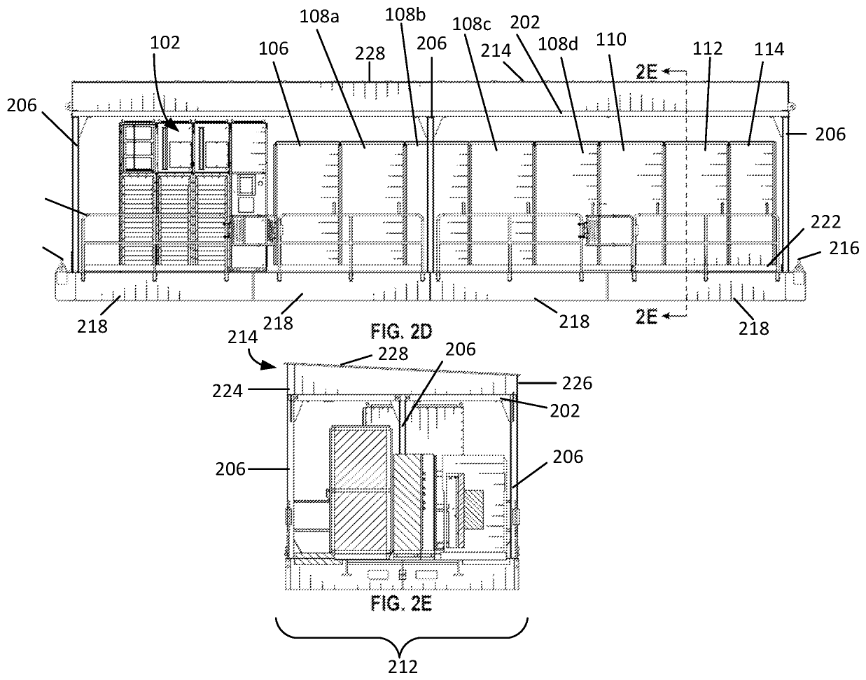

Turning to FIGS. 2A-2E, side, front, and back views of the skid 100 are shown, according to one embodiment of the present disclosure. As shown in FIG. 2A, the skid 100 may include a frame 201, which may include one or more top supports 202, one or more bottom supports 204, and one or more vertical supports 206 that connect the one or more top supports 202 to the one or more bottom supports 204. The skid 100 may have a height 208, a length 210, and a width 212 (shown in FIG. 2B). In some embodiments, the height 208 may be between six feet and fifteen feet. In at least one embodiment, the height 208 may be between about eleven feet to about thirteen feet. In some embodiments, the length 210 may be between thirty feet and fifty feet. In at least one embodiment, the length 210 may be between forty feet and forty-three feet. In one embodiment, the length 210 may not be longer than the length of a standard flatbed trailer, which is about fifty-five feet. In some embodiments, the width 212 of the skid 100 may be between ten feet and fifteen feet, and may, in a particular embodiment, be between about 12.5 feet to 13.5 feet.

In many embodiments, as shown in FIGS. 2B and 2E, the skid 100 may also include a roof 214. The roof 214 may include a first roof support 224 and a second roof support 226, and a roof surface 228 that is on top of the first roof support 224 and second roof support 226. In at least one embodiment, the first roof support 224 may be taller or longer than the second roof support 226, such that the roof surface 228 slopes downward at an angle from the first roof support 224 to the second roof support 226. The slope of the roof surface 228 allows for water or other debris to flow down the slope and onto the ground beside the skid 100. In many embodiments, the skid 100 may also include connection devices 216 (as shown in more detail in FIG. 2C), which may be utilized to pull the skid 100 on or off a trailer or to position the skid 100 at the site. The skid 100 may also include skirting 218 that substantially covers a bottom portion of the skid 100, and a floor 222, on which many of the electrical components are placed. In some embodiments, and as shown in FIGS. 2B and 2D, the skirting 218 may extend around the outer portion of the frame 201 and extend downward below the floor 222, such that there is a space defined below the floor 222 in which cables or other electrical components may be placed. In at least one embodiment, the skid 100 may include a handrail 220 that extends vertically up from the floor 222 and is placed around the perimeter of the skid 100, for safety purposes.

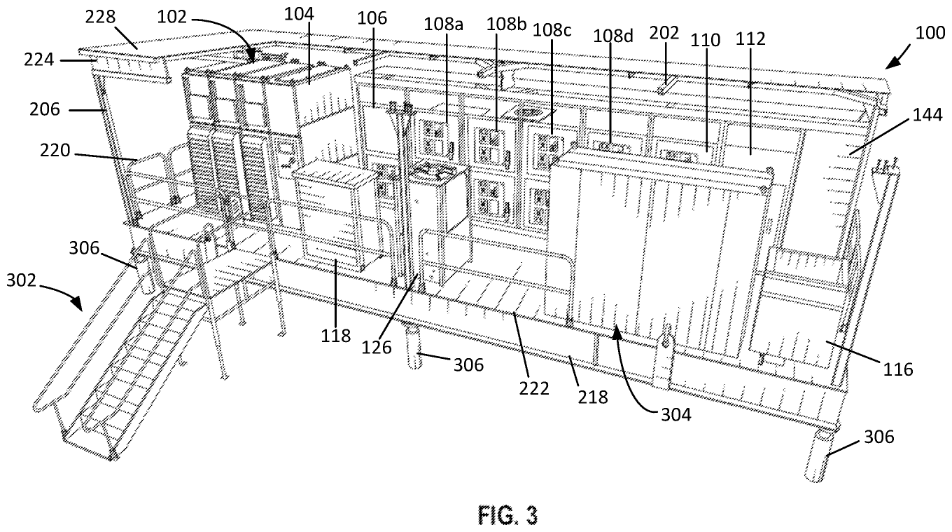

Turning to FIG. 3, a perspective view of the skid 100 is shown, according to one embodiment of the present disclosure. The skid 100 as shown in FIG. 3 may include a set of stairs 302 to allow a user to access the floor 222 of the skid 100. The skid 100 may also include a plurality of ground supports 306 that extend from the bottom supports 204 and/or the skirting 218 and are in contact with the ground, so that the body of the skid 100 is lifted some height from the ground when in placed at a site. Lifting the skid 100 off of the ground further allows for cables or other components to run underneath the floor 222 and/or skirting 218 of the skid 100.

Additionally, as shown in FIG. 3, the skid 100 may include a low voltage power and control cabinet 304, which contains the transformer 120, the power distribution center 122, the uninterruptible power supply and programmable logic controller 124, and the load distribution center 128.

Further, as shown in the FIGS. 1-4, the skid 100 does not include side walls in between the top supports 202 and the floor 222. The lack of side walls creates an “open-air” skid 100. Because the skid 100 is “open-air,” a user of the skid 100 does not have to get building permits or hazardous gases permits to implement the skid 100 at a site.

Turning to FIG. 4, a perspective view of the skid 100 connected to a powerline 402 is shown, according to one embodiment of the present disclosure. As shown in FIG. 4, the skid 100 may be connected to a powerline 402. In some embodiments, the powerline 402 may be a medium or high voltage powerline. In at least one embodiment, the powerline 402 may be connected to a transformer 404 and/or a switchgear 404. In many embodiments, the transformer 404 may be a high voltage transformer or a medium voltage transformer. In some embodiments, the power may run from the powerline 402 to the transformer 404 to the switchgear 406 to the skid 100 (at input cabinet 114); however, in other embodiments, the switchgear 406 and/or transformer 404 may not be utilized. Still, in other embodiments, multiple switchgears (e.g., switchgear 406) or transformers (e.g., transformer 404) may be utilized in providing power from the powerline 402 to the skid 100. In multiple embodiments, the skid 100 may also include cables 408 that connect each of the natural gas compressors with the motor relays 108.

In several embodiments, the open-air, electrical drive skid 100 may be transported to a first site that includes a first set of natural gas compressors (e.g., a site on a natural gas pipeline). Once at the first site, the open-air, electrical drive skid 100 may be electrically connected to a high voltage or medium voltage power line 402 on one end and to one or more natural gas compressors at another end. The variable drive 102 may provide power to start-up a first natural gas compressor via a first motor control cabinet 108a. At start-up, a start contactor within the first motor control center closes, which connects the drive 102 and sync reactor 118 to the first compressor. After the first compressor is started up and is at power and frequency, a start contactor in the first motor control cabinet 108a opens, so that the sync reactor 118 and drive 102 are switched off the first compressor, and a run contactor in the first motor control cabinet 108a closes. The run contactor connects the first compressor to utility power, which is supplied by the skid 100 as well, and provides power to the first compressor to keep the first compressor running after start-up. Once the sync reactor 118 and drive 102 are switched off the first compressor, the sync reactor 118 and drive 102 can be used to start-up a second natural gas compressor, using the same method as described above. Once the second compressor is at power and frequency, the skid 100 can switch the second compressor from the sync reactor 118 and drive 102 to utility power, and the sync reactor 118 and drive 102 can be used to start a third natural gas compressor. Once the third compressor is at power and frequency, the skid 100 can switch the third compressor from the sync reactor 118 and drive 102 to utility power, and the sync reactor 118 and drive 102 can be used to start a fourth natural gas compressor.

In one or more embodiments, the skid 100 may be transported to a second site that includes a second set of natural gas compressors (e.g., a second site on a natural gas pipeline). Once at the first site, the open-air, electrical drive skid 100 may be electrically connected to a high voltage or medium voltage power line 402 on one end and to one or more natural gas compressors at another end, and may utilize the electrical power to start-up and run one or more of the second set of natural gas compressors, as described herein.

The skid 100 may be transported on a flat-bed tractor trailer, or another mode of transportation that may transport the entirety of the skid 100. The connection devices 130 and 216 may be utilized to move the skid 100 from the ground at the first site to the trailer and secure the skid 100 on the trailer, and then may be utilized to move skid 100 from the trailer to the ground at the second site. Because the skid 100 is “open-air,” a user can utilize the skid 100 in several different locations without having to get different permits or reconstruct or refabricate the skid to meet certain local requirements regarding hazardous waste or other requirements.

### CONCLUSION

Aspects, features, and benefits of the systems, methods, processes, formulations, apparatuses, and products discussed herein will become apparent from the information disclosed in the exhibits and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the inventions to the precise forms disclosed. Many modifications and variations are possible in light of the above teaching.

The embodiments were chosen and described in order to explain the principles of the inventions and their practical application so as to enable others skilled in the art to utilize the inventions and various embodiments and with various modifications as are suited to the particular use contemplated. Alternative embodiments will become apparent to those skilled in the art to which the present inventions pertain without departing from their spirit and scope. Accordingly, the scope of the present inventions is defined by the appended claims rather than the foregoing description and the exemplary embodiments described therein.

While various aspects have been described in the context of a preferred embodiment, additional aspects, features, and methodologies of the claimed inventions will be readily discernible from the description herein, by those of ordinary skill in the art. Many embodiments and adaptations of the disclosure and claimed inventions other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed inventions. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed inventions. In addition, some steps may be carried out simultaneously, contemporaneously, or in synchronization with other steps.

The embodiments were chosen and described in order to explain the principles of the claimed inventions and their practical application so as to enable others skilled in the art to utilize the inventions and various embodiments and with various modifications as are suited to the particular use contemplated. Alternative embodiments will become apparent to those skilled in the art to which the claimed inventions pertain without departing from their spirit and scope. Accordingly, the scope of the claimed inventions is defined by the appended claims rather than the foregoing description and the exemplary embodiments described therein.

What is claimed is:

1. A system, comprising:
an open-air skid, further comprising:
an electric drive, and
a sync reactor;
wherein the electric drive and sync reactor provide electrical power to one or more natural gas compressors.

2. The system of claim 1, wherein the open-air skid further comprises an input cabinet that provides utility power from a high voltage power line to the electric drive and sync reactor.

3. The system of claim 2, wherein the open-air skid further comprises a plurality of motor control cabinets.

4. The system of claim 3, wherein each of the plurality of motor control cabinets is connected to a separate natural gas compressor of the one or more natural gas compressors.

5. The system of claim 4, wherein the electric drive and the sync reactor provide electrical power to the one or more natural gas compressors comprises:
providing start-up power to a first natural gas compressor of the one or more natural gas compressors via the electric drive and the sync reactor;
transferring the first natural gas compressor from start-up power to utility power provided by the input cabinet; and
providing start-up power to a second natural gas compressor of the one or more natural gas compressors via the electric drive and the sync reactor.

6. The system of claim 5, wherein the one or more natural gas compressors comprises four natural gas compressors.

7. The system of claim 6, wherein each of the four natural gas compressors exerts up to 2500 horsepower.

8. The system of claim 1, wherein the skid further comprises:
a height in between, and including, 11 feet to 13 feet,
a length in between and including 40 feet to 43 feet, and
a width in between and including 10 feet to 15 feet.

9. The system of claim 1, wherein the skid does not comprise side walls.

10. The system of claim 1, wherein the open-air skid further comprises a plurality of motor control cabinets, a step-down transformer, and a remote cooling unit;
wherein the remote cooling unit cools the electric drive.

11. A method of providing electric power to a first set of one or more natural gas compressors, comprising:
providing an open-air skid at a first site, the open-air skid comprising:
an electric drive,
one or more motor control cabinets,
a sync reactor, and
an input cabinet;
connecting the input cabinet to a high voltage power line,
providing start-up power to a first natural gas compressor of the first set of one or more natural gas compressors via the electric drive and sync reactor;
transferring the first natural gas compressor from start-up power to utility power provided by the input cabinet,
providing start-up power to a second natural gas compressor of the first set of one or more natural gas compressors via the electric drive and the sync reactor, and
transferring the second natural gas compressor from start-up power to utility power provided by the input cabinet.

12. The method of claim 11, wherein transferring the first natural gas compressor from start-up power to utility power provided by the input cabinet comprises:
syncing, by the sync reactor, a power and frequency of the first natural gas compressor with a power and frequency of the utility power,
removing the start-up power provided by the electric drive and sync reactor, and
connecting the utility power with the synced first natural gas compressor.

13. The method of claim 11, further comprising:
providing start-up power to a third natural gas compressor of the first set of one or more natural gas compressors via the electric drive and the sync reactor;
transferring the third natural gas compressor from start-up power to utility power provided by the input cabinet;
providing start-up power to a fourth natural gas compressor of the first set of one or more natural gas compressors via the electric drive and the sync reactor; and
transferring the fourth natural gas compressor from start-up power to utility power provided by the input cabinet.

14. The method of claim 11, wherein the open-air skid further comprises:
a height in between, and including, 11 feet to 13 feet,
a length in between and including 40 feet to 43 feet, and
a width in between and including 10 feet to 15 feet.

15. The method of claim 11, wherein the open-air skid does not comprise side walls.

16. The method of claim 11, further comprising:
transporting the open-air skid to a second site having a second set of one or more natural gas compressors;
providing start-up power to a third natural gas compressor of the second set of one or more natural gas compressors via the electric drive and sync reactor;
transferring the third natural gas compressor from start-up power to utility power provided by the input cabinet,
providing start-up power to a fourth natural gas compressor of the second set of one or more natural gas compressors via the electric drive and the sync reactor, and
transferring the fourth natural gas compressor from start-up power to utility power provided by the input cabinet.
